(19) United States
(12) Patent Application Publication
(10) Pub. No.: US 2007/0279163 A1
(43) Pub. Date: Dec. 6, 2007

(54) Monitorable securing means

(75) Inventor: Max Schmid, Wangs (CH)

Correspondence Address: BUCHANAN, INGERSOLL & ROONEY PC, POST OFFICE BOX 1404, ALEXANDRIA, VA, 22313-1404, US

(73) Assignee: Elesta Relays GmbH, Bad Ragaz (CH)

(21) Appl. No.: 11/806,417

(22) Filed: May 31, 2007

(30) Foreign Application Priority Data
Jun. 1, 2006 (CH) 00880/06

(51) Int. Cl. H01H 51/22

(52) U.S. Cl. 335/78

(57) ABSTRACT

An exemplary securing means has an electromagnet which has a core, a coil and a yoke which can be moved away from the core and which closes the magnetic circuit of the electromagnet. This securing means is provided with an electrical or electronic switching device which responds to a magnetic field for monitoring of the magnetic field in the magnetic circuit. This switching device taps the core or the yoke at two sites which are spaced apart from one another in the lengthwise direction of the magnetic flux. Thus, the switching device reacts distinctly to the gap width between the core and the yoke. For example, a reed switch drops out at a gap width of 0.02 mm, but is clearly activated when the magnetic circuit is closed.

### RELATED APPLICATIONS

This application claims priority under 35 U.S.C. §119 to Swiss Application 00880/06 filed in Switzerland on Jun. 1, 2006, the entire contents of which are hereby incorporated by reference in their entireties.

### TECHNICAL FIELD

The disclosure relates to a monitorable securing means with an electromagnet and a yoke which fits the electromagnet for keeping a part closed which is to be held closed for safety, and with a sensor for monitoring the state of the securing means.

### BACKGROUND INFORMATION

DE 203 06 708 U1 discloses an access control means which comprises a magnetizable yoke on a movable part and an electromagnet which can be closed with the yoke on a stationary part. The access control means is moreover provided with a sensor unit which can send and receive a high frequency signal. There is a response transmitter on the movable part. Furthermore there is a magnetic field sensor which is located adjacent to a contact surface between the magnet and the yoke. This arrangement adjacent to the contact surface enables accurate detection of the locking force which is in fact applied by the magnet based on the stray field which occurs most strongly there. Even a small air gap is recognized based on the scattering.

Accordingly the magnetic field outside the magnetic circuit in the region between the magnet core and the yoke is measured by means of a magnetic field sensor. If the magnet core and yoke are near one another, the measured magnetic field is small. If the magnet core and yoke are however separated from one another, the measured magnetic field becomes larger. The disadvantage of this arrangement is that the magnetic field is also small if the magnetic coil is not excited. Another disadvantage is that a magnetic field sensor separated from the magnetic coil and from the core need be mounted separately.

GB 2 205 603 A discloses a holding magnet for cabinet doors. The holding magnet is provided with two permanent magnets which are provided on their poles with one soft iron plate projecting forward and one projecting backward. These soft iron plates pass through a housing on the front at two sites at a time and can attract a yoke-like soft iron rod which is attached to the cabinet door. The yoke-like soft iron rod connects simply one pole of one permanent magnet to one pole of the other permanent magnet. The poles of the two magnets which are opposite at the time with the door closed are located simply near the yoke-like soft iron rod. A reed switch extends from one of the two poles which can be closed by the yoke-like soft-iron rod. In the opened state of the door the yoke-like soft iron rod is outside the influence region of the two permanent magnets. These two permanent magnets can then actuate the reed switch so that a light in the cabinet is turned on. But with the door closed the permanent magnets are no longer strong enough to actuate the reed switch.

In one alternative embodiment the reed switch is arranged such that it opens when the soft iron rod is moved away from the poles, and closes when the soft iron rod connects the poles. These embodiments can be used for switching of lights, radios, music systems, alarm bells, or position sensors. Instead of permanent magnets, electromagnets can also be used.

JP-A-7220594 discloses a magnetic proximity switch which consists of two oppositely polarized permanent magnets located next to one another, and a reed switch. The reed switch extends in the lengthwise direction from one pole of one magnet to the other pole of the other magnet. On the side of the two permanent magnets which is opposite the reed switch they attract a door, a cover or the like of for example a copy machine. If the door is closed, the two poles of the permanent magnets which are next to one another are bridged with a type of yoke. On one side of the reed switch this yields a stronger magnetic field between the poles there so that the reed switch responds to the magnetic field. With the reed switch it can therefore be detected whether the cover is held by the two magnets or not.

In order to be able to achieve a small size, it is suggested that one of the two permanent magnets be made from isotropic material, the other of anisotropic material, and to provide a magnetic yoke. This makes it possible to place the reed switch very near the magnetic yoke.

One disadvantage of these known proximity sensors which generate a holding force is that two magnets are necessary and that they must manage with low holding forces in order not to actuate the reed switch in the opened state.

### SUMMARY

A securing means is disclosed which can be turned on and off and which can develop large holding forces and can be monitored for example with a reed contact or an other electrical or electronic switching device which responds to a magnetic field. The monitoring is designed to indicate whether the securing means is closed and turned on and the required holding force is reached or whether it is open.

An exemplary securing means is equipped with an electromagnet and with an electrical or electronic switching device which responds to a magnetic field for monitoring of the magnetic field in the magnetic circuit. The electromagnet has a core, a coil and a yoke which can be moved away from the core and which closes the magnetic circuit of the electromagnet. In this securing means the switching device taps the core or the yoke at two sites which are spaced apart from one another in the lengthwise direction of the magnetic flux. In this way a value is detected which corresponds to the drop of the magnetomotive force over the length of the tapped section. This drop of the magnetomotive force is dependent on the air gap width between the yoke and core.

The switching device can be a reed switch which is located in the lengthwise direction to the magnetic circuit in or on the core or in or on the yoke. This execution of the switching device has the advantage of small dimensions of the switch and of invulnerability to environmental effects. The construction of the securing means can be accordingly compact and simple.

But for other applications the switching device can be a relay. The drive of the relay comprises a magnetic circuit with a unshaped core and a movable armature which closes the magnetic circuit, and has an actuating comb which is actuated by the armature. The core of the relay is guided over a section parallel to the core or yoke of the electromagnet and therefore taps the magnetic flux at the end sites of this section. Thus the drop of the magnetomotive force over this section can be measured with this arrangement.

In a third exemplary embodiment, the switching device is a Hall sensor.

Due to the small dimensions of the Hall sensor, it is necessary for this that the switching device is located between the two arms of a magnetizable material which are connected to the core or the yoke at sites spaced apart from one another, or between one arm and one site on the core away from the connecting site of this arm. This arrangement is however also possible in the other switching devices in order to obtain a greater magnetic resistance between the two tapping sites on the magnetic core/yoke. The greater resistance yields a greater magnetic force in the switching device. The U-shaped core of the relay actually forms such an arm.

These switching devices are advantageously connected to electronics which monitor and control the functions of the securing means and interprets the signals of the switching device.

### BRIEF DESCRIPTION OF THE DRAWINGS

Brief description of the figures is as follows:

FIG. 1 shows an exemplary securing means with different switching devices placed at various sites on the core and on the yoke, in a schematic cross section in order to illustrate the various possibilities in a single representation,

FIG. 2 shows a schematic of the magnetic circuit in the core, yoke and air gap,

FIG. 3 shows an exemplary magnetomotive force in the core as a function of the air gap width as a curve.

### DETAILED DESCRIPTION

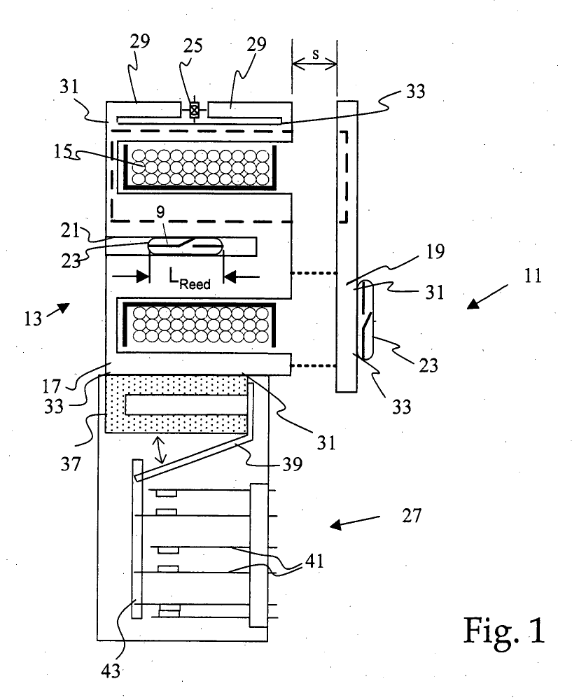

FIG. 1 shows an exemplary securing means 11 with several exemplary switching devices. The exemplary switching devices are shown for purposes of illustration. In economical exemplary embodiments, at least one of these exemplary switching devices can be present, perhaps duplicated.

The securing means 11 has an electromagnet 13 which has a coil 15 around a core 17 and a yoke 19. The coil can be connected to a current source (not shown) in order to operate the electromagnet. The core 17 of the electromagnet forms a “cup” with a “centerpole”. With these magnets very high magnetic forces are achieved between the core 17 and the yoke 19. For a securing means, locking forces of roughly 50 to 200 kg are feasible to reliably prevent opening of the closed door.

In the center core of this magnet 13 there is a hole 21 in which there is a reed switch. This reed switch can be activated simply by the coil only when the yoke is closed and therefore there is high magnetomotive force in the core.

In the electromagnetic securing means the coil 15 produces magnetomotive force Θ. This magnetomotive force Θ is concentrated due to its magnetic properties mainly in the core 17 and yoke 19. If the yoke 19 lies on the core 17 without an air gap s, the magnetomotive force Θ is distributed uniformly in the magnetic circuit. For a small air gap s the magnetomotive force Θ in iron is smaller, in the air gap it however increases. The sum of the magnetomotive force Θ in the iron and in the air gap is constant and is given by the electrical current I which is routed through the coil 15 and the number of windings of the coil 15 (the magnetomotive force is therefore given in AW, ampere windings).

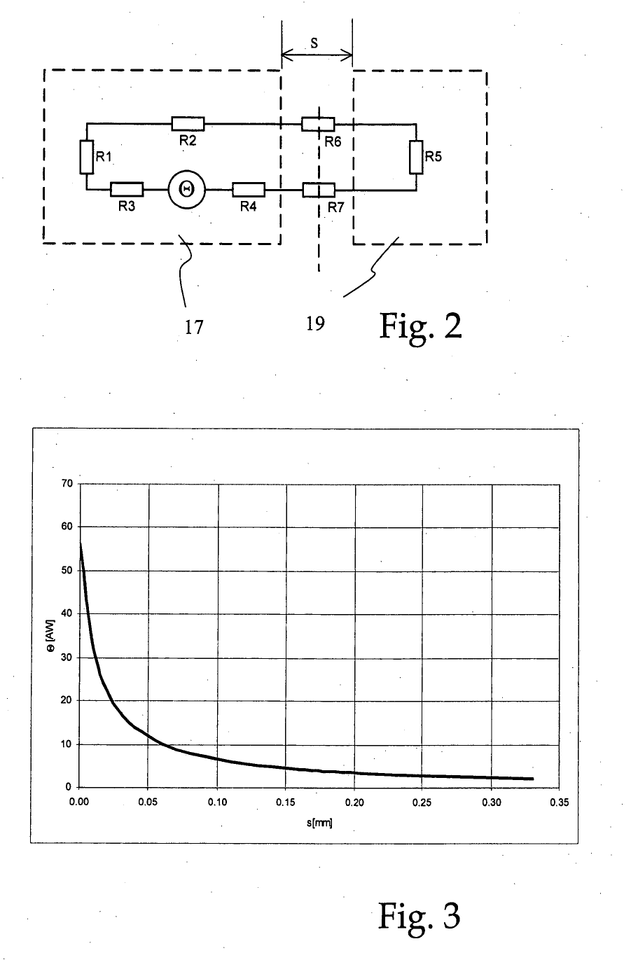

Each part in the magnetic circuit has a magnetic resistance R1, R2, R3, R4, R5, R6, R7. This is shown schematically in FIG. 2. The magnetic resistance of the iron core and of the yoke is smaller by a few orders of magnitude than the magnetic resistance R6, R7 of the air in the air gap s. The magnetic flux Φ in the core and in the air gap is dependent on the electrical magnetomotive force Θ and the magnetic resistance Rₜₒₜₐₗ of the magnetic circuit. For a large air gap s the magnetic flux Φ is therefore small compared to the magnetic flux Φ for a small air gap. Since for a large air gap the magnetomotive force Θ is “consumed” to maintain the magnetic field in the region of the air gap s, in the region of the core this yields smaller magnetomotive force Θ.

Due to the great differences with respect to the magnetic resistance R of air and iron the magnitude of the magnetomotive force Θ of the iron core or of the yoke is very distinctly dependent on the air gap width. For a small air gap s the magnetomotive force Θ in iron is large, for a large air gap, small. The magnetomotive force Θ in the core can be tapped according to the voltage drop over one conductor per section. The magnetic resistance R1, R2 over the tap length relative to the total magnetic resistance Rₜₒₜₐₗ of the part corresponds to the magnetomotive force Θ of the section relative to the total magnetomotive force Θ of the part. The decrease of the magnetomotive force Θ is accordingly large and small over the length of a sensor and between the two tapping sites of the sensor, respectively

The following applies

Rₜₒₜₐₗ=R1+R2+ . . . +R6+R7=Lᵢᵣₒₙ/(μ₀*μᵣ*Aᵢᵣₒₙ)+Lₐᵢᵣ/(μ₀*Aₐᵢᵣ)

Φ=Θ/Rₜₒₜₐₗ=N*I/Rₜₒₜₐₗ (similar to Ohm's law)

Θ=Φ*R_{Reed}/Rₜₒₜₐₗ=N*I*R_{Reed}/Rₜₒₜₐₗ

R_{Reed}=magnetic resistance in iron over the length of the reed contact (for example R2)

Φ=magnetic flux

Θ=magnetomotive force

FIG. 3 shows an exemplary magnetomotive force Θ in the iron over the length of the reed contact of 20 mm as a function of the air gap. For sensitivity of the reed contact of 30 AW the reed contact is turned on if the air gap is smaller than roughly 0.02 mm.

Reed switches 23, Hall elements 25 and relays 27 are suggested as sensors (see FIG. 1). They can be located in the core 17, on the core, in the yoke 19 or on the yoke 19. Proximity to the magnetic circuit is necessary when it is not tapped over magnetizable arms. With arms of magnetizable material the sensor can also be located at a distance to the magnetic circuit. It can then be located between the ends of the arms.

Based on the small dimensions of the Hall element 25 the difference sampled by the sensor alone in the magnetomotive force is very small. A Hall element, as shown in FIG. 1, can tap a larger section of the core 17 via one or two arms 29 of magnetizable material. Between the ends of the arms a magnetic field is formed according to the difference of the magnetomotive force between the two tapping sites 31, 33.

The reed contact can be located in a hole 21 in the iron or on the surface of the iron of the core 17 or of the yoke 19. A magnetic, electrically nonconductive contact via ferrites between the core and the conductors of the reed contact is not necessary.

Instead of a reed contact, an electromechanical relay 27 (without a coil) can also be used. With a u-shaped core 37 which corresponds to the core of an electromagnetic drive of the relay, the core 17 of the electromagnet 13 is tapped. The tapped part of the magnetomotive force of the core 17 causes a magnetic circuit in the core 37 of the relay 27. This relay-magnetic circuit is very weak when the air gap s for the electromagnet 13 is large. In this case the armature (39) drops off the core under the action of a spring force. The relay-magnetic circuit is conversely relatively strong in order to drive the relay when the air gap is small. Then the armature 39 is attracted against the spring force and the relay is switched.

The relay 27 can have several contact pairs 41. There can be make contacts and break contacts which are actuated at the same time by a common actuating comb 43. The relay can be a positive-action safety relay. The relay compared to the reed contact has the advantage that it has higher contact ratings and can execute more switching movements than the reed contact. Furthermore, it has the advantage that it can have changeover contacts, make contacts and break contacts as needed in any combinations and thus is extremely flexible and reliable. The relay is especially suited for safety applications.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Securing means
with an electromagnet which has a core, a coil and a yoke which can be moved away from the core and which closes the magnetic circuit of the electromagnet, and
with an electrical or electronic switching device which responds to a magnetic field for monitoring of the magnetic field in the magnetic circuit,
in which securing means the switching device taps the core or the yoke at two sites which are spaced apart from one another in the lengthwise direction of the magnetic flux.

2. Securing means as claimed in claim 1, wherein the switching device is a reed switch which is located in the lengthwise direction to the magnetic circuit in or on the core or in or on the yoke.

3. Securing means as claimed in claim 1, wherein the switching device is a relay with a drive which comprises a magnetic circuit with a u-shaped core and a movable armature which closes the magnetic circuit, and has an actuating comb which is actuated by the armature, the core of the drive being guided over a section parallel to the core or yoke of the electromagnet.

4. Securing means as claimed in claim 1, wherein the switching device is a Hall sensor.

5. Securing means as claimed in claim 1, wherein the switching device is located between two arms of a magnetizable material which are connected to the core or the yoke at sites which are spaced apart from one another.

6. Securing means as claimed in claim 2, wherein the switching device is located between two arms of a magnetizable material which are connected to the core or the yoke at sites which are spaced apart from one another.

7. Securing means as claimed in claim 3, wherein the switching device is located between two arms of a magnetizable material which are connected to the core or the yoke at sites which are spaced apart from one another.

8. Securing means as claimed in claim 4, wherein the switching device is located between two arms of a magnetizable material which are connected to the core or the yoke at sites which are spaced apart from one another.

9. A securing apparatus, comprising:
an electromagnet which has a core, a coil and a movable yoke; and
a switching device which responds to a magnetic field for monitoring of the magnetic field, wherein the switching device taps at least one of the core and the yoke in a general direction of a magnetic flux.
